(19) United States
(12) Patent Application Publication
(10) Pub. No.: US 2008/0163461 A1
(43) Pub. Date: Jul. 10, 2008

(54) Display rotation apparatus

(75) Inventors: Dong-Won Choi, Suwon-si (KR); Chil-Sung Lee, Suwon-si (KR); Jae-Kyung Kim, Ansan-si (KR); Jae-Hun Kim, Suwon-si (KR); Kyoung-Shin Park, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/007,044

(22) Filed: Jan. 4, 2008

(30) Foreign Application Priority Data
Jan. 8, 2007 (KR) 10-2007-0001985

(51) Int. Cl. E05D 3/10

(52) U.S. Cl. 16/367

(57) ABSTRACT

A display rotation apparatus includes: a support member; an arm, of which one end is coupled to the support member by way of a first hinge part interposed in-between, such that the arm is rotatable in a direction intersecting a direction of gravity; a connection member, which is coupled to the other end of the arm by way of a second hinge part interposed in-between, such that the connector member is rotatable in a direction intersecting the direction of gravity; and a movement member, which is coupled to the connection member by way of a third hinge part interposed in-between, such that the movement member is rotatable in the direction of gravity, where a drive part is coupled to each of the first hinge part, the second hinge part, and the third hinge part. The apparatus can be used to automatically rotate a display.

### CROSS-REFERENCE TO RELATED APPLICATIONS

This application claims the benefit of Korean Patent Application No. 10-2007-0001985 filed with the Korean Intellectual Property Office on Jan. 8, 2007, the disclosure of which is incorporated herein by reference in its entirety.

### BACKGROUND

1. Technical Field

The present invention relates to a display rotation apparatus.

2. Description of the Related Art

Flat panel displays, such as TV sets and monitors, employing LCD, PDP, LED technology, etc., provide the benefit of allowing efficient use of small spaces, and are fast replacing Braun tube TV's and monitors. The increase in demand for such flat panel displays is expected to continue into the future. In particular, flat panel LCD or PDP TV's, often referred to as “wall-mount TV's,” are affixed to wall surfaces for use. When viewing a wall-mount TV thus affixed, the largest viewing angle is achieved directly in front of the TV.

However, when the TV is fixed to a wall surface, the position that allows the largest viewing angle of the TV screen is also fixed, and as a viewer changes position, adequate viewing may not be obtained.

### SUMMARY

An aspect of the claimed invention is to provide a display rotation apparatus, which allows the display to rotate and thereby ensures a desired viewing angle, while allowing the display to be rotated smoothly with even a low-output motor.

One aspect of the invention provides a display rotation apparatus, which includes: a support member; an arm, of which one end is coupled to the support member by way of a first hinge part interposed in-between, such that the arm is rotatable in a direction intersecting a direction of gravity; a connection member, which is coupled to the other end of the arm by way of a second hinge part interposed in-between, such that the connector member is rotatable in a direction intersecting the direction of gravity; and a movement member, which is coupled to the connection member by way of a third hinge part interposed in-between, such that the movement member is rotatable in the direction of gravity, where a drive part is coupled to each of the first hinge part, the second hinge part, and the third hinge part.

An elastic member may be coupled between the connection member and the movement member, and may apply an elastic force on the movement member in a direction opposite the direction of gravity. This is so that if a display is coupled to the movement member, the display may be prevented from drooping downwards because of the pull of gravity.

The drive part may include a motor, and a gear module coupled to the motor that decelerates a rotation speed of the motor. The gear module may increase the final output torque.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view of a display rotation apparatus according to an embodiment of the present invention.

FIG. 2 is an exploded perspective view of a display rotation apparatus according to an embodiment of the present invention.

FIG. 3 is a side-elevational view of a display rotation apparatus with a display coupled on, according to an embodiment of the present invention.

FIG. 4 is a perspective view of a drive part used in a display rotation apparatus according to an embodiment of the present invention.

### DETAILED DESCRIPTION

The display rotation apparatus according to certain embodiments of the invention will be described below in more detail with reference to the accompanying drawings. Those components that are the same or are in correspondence are rendered the same reference numeral regardless of the figure number, and redundant explanations are omitted.

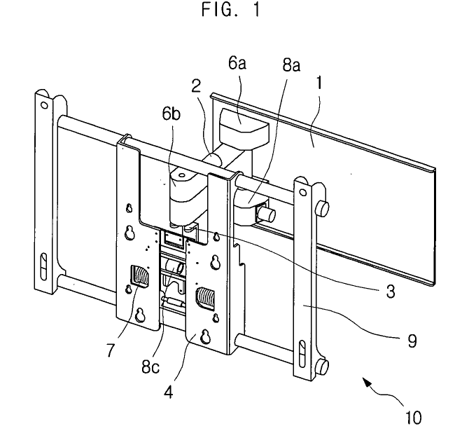

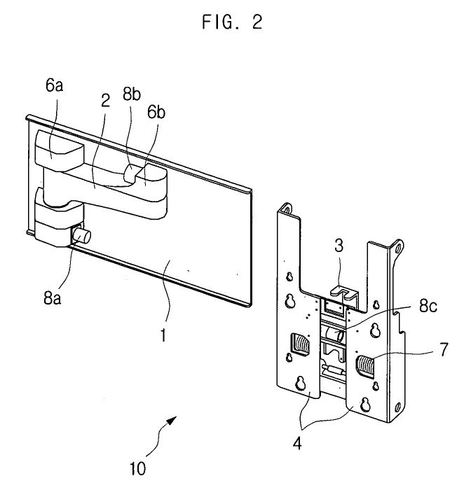

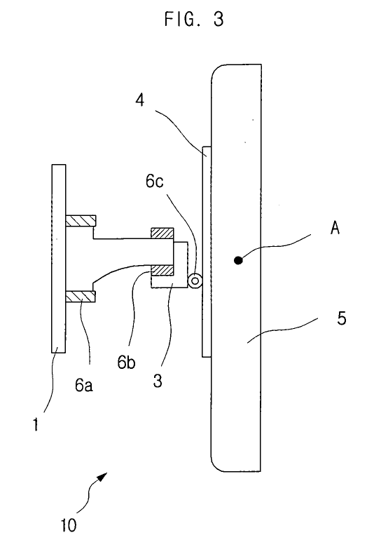

FIG. 1 is a perspective view of a display rotation apparatus according to an embodiment of the present invention, FIG. 2 is an exploded perspective view of a display rotation apparatus according to an embodiment of the present invention, and FIG. 3 is a side-elevational view of a display rotation apparatus with a display coupled on, according to an embodiment of the present invention. In FIG. 1 through FIG. 3, there are illustrated a display rotation apparatus 10, a support member 1, an arm 2, a connection member 3, a movement member 4, a display 5, a first hinge part 6a, a second hinge part 6b, a third hinge part 6c, elastic members 7, drive parts 8a, 8b, 8c, and auxiliary members 9.

A display rotation apparatus 10 according to this embodiment may be coupled to a fixed body (e.g. a wall or a column, not shown) and may have the arm 2 extend from the fixed body. A flat panel type display 5 may be coupled to the display rotation apparatus 10, which can be made to rotate in the direction of gravity, as well as in a direction intersecting the direction of gravity.

In describing this embodiment, a “direction of gravity” refers to the direction of gravity pull when the display rotation apparatus 10 is placed on a flat location, while the “direction intersecting a direction of gravity” refers to the direction that can be perpendicular to the direction of gravity pull. As the “direction of gravity” and the “direction intersecting the direction of gravity” are possible in idealized embodiments, those embodiments having mechanical tolerances and errors in reality are encompassed within the scope of the invention, as are those embodiments that entail intentional tolerances and errors designed around the idealized embodiments.

The display rotation apparatus 10 of this embodiment can be composed mainly of a support member 1 which may be coupled to a fixed body, an arm 2 which may have one end coupled to the support member 1 by way of an interposed first hinge part 6a and which can be rotated in a direction intersecting the direction of gravity, a connection member 3 which may be coupled to the other end of the arm 2 by way of an interposed second hinge part 6b and which can be rotated in a direction intersecting the direction of gravity, and a movement member 4 which may be coupled with the connection member 3 by way of an interposed third hinge part 6c and which can rotate in the direction of gravity.

The support member 1 can be the member coupled to a fixed body (not shown, may be a wall or a column, etc.), and can have any of a variety of shapes according to the surface of the object to which it is coupled. For instance, if the support member 1 is coupled to a wall, it may have a generally flat shape, whereas if the support member 1 is coupled to a cylindrical column, it may be fabricated to have a shape corresponding to the circumference of the column. The support member 1 may be such that supports the entire weight of the display (not shown) coupled to the display rotation apparatus 10, and accordingly may require a sufficient strength. In certain cases, a metallic material may generally be used.

The arm 2 may be coupled on one end to the support member 1 with the first hinge part 6a interposed in-between, such that the arm 2 is able to rotate in a direction intersecting the direction of gravity. Here, “intersecting” not only includes those cases where the rotation is perpendicular to the direction of gravity, but also encompasses rotation in a direction tilted in a certain angle. A drive part 8a may be coupled to the first hinge part 6a. The drive part 8a may include a motor (not shown). Due to the rotational force of the motor, the arm 2 can be made to rotate automatically. The connection member 3 may be coupled on the other end of the arm 2 with the second hinge part 6b interposed in-between. Thus, the connection member 3 can be made to rotate at the other end of the arm 2 in a direction intersecting the direction of gravity. The rotation axis of the first hinge part 6a may be substantially parallel to the rotation axis of the second hinge part 6b. A drive part 8b may be coupled also to the second hinge part 6b, to allow the connection member 3 to rotate automatically. The drive part 8b can have the same structure as the drive part 8a described above.

The movement member 4 may be coupled to the connection member 3 with the third hinge part 6c interposed in-between. The movement member 4 may rotate in the direction of gravity relative to the connection member 3. Of course, it is apparent that the movement member 4, after having rotated in the direction of gravity, can rotate back in a direction opposite the direction of gravity, to return to its original position. A display 5 may be coupled to the movement member 4. To facilitate the coupling between the movement member 4 and the display 5, additional auxiliary members 9 may be coupled to the movement member 4, as illustrated in FIG. 1.

As such, when a display 5 is coupled to the movement member 4, the display rotation apparatus 10 according to this embodiment allows the display 5 to automatically extend relative to the support member 1 and to rotate in the direction of gravity and in a direction intersecting the direction of gravity.

In cases where there are no apparatuses added between the display 5 and the movement member 4, the display 5 may droop downwards about the third hinge part 6c due to the pull of gravity. Therefore, in order to keep the display 5 horizontal with respect to gravity, elastic members 7 may be coupled between the connection member 3 and the movement member 4, as illustrated in FIG. 2. The elastic members 7 may apply elastic forces in a direction opposite the direction of gravity, to prevent the display 5 from drooping downwards. The coupling position of the display 5 and the third hinge part 6c may also be important in reducing the drooping of the display 5. As illustrated in FIG. 3, forming the third hinge part 6c at a position lower than the center of mass (A) of the display 5 can reduce the gravitational moment of the display 5, so that the elastic members 7 may be able to maintain the display 5 parallel to the direction of gravity with a minimal amount of elastic force.

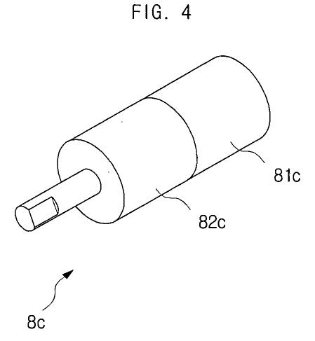

A drive part 8c may be coupled to the third hinge part 6c. As illustrated in FIG. 4, the drive part 8c may include a motor 81c and a gear module 82c. The gear module 82c may serve to decelerate the rotation speed of the motor 81c and increase the output torque. The drive part 8c enables the movement member 4 to rotate in the direction of gravity. The drive part 8c encompasses several gear members (e.g. worm gear, etc.) necessary for rotating the movement member 4. The drive parts 8a, 8b positioned at the first hinge part 6a and the second hinge part 6b are also analogous to the drive part 8c described above for the third hinge part 6c.

According to certain embodiments of the invention as set forth above, a display can be extended from a fixed body (e.g. a wall surface), and can be made to rotate in the direction of gravity and a direction intersecting the direction of gravity. Such a display rotation apparatus may provide a wider range of viewing angles for the viewer.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A display rotation apparatus comprising:
a support member;
an arm having one end thereof coupled to the support member by way of a first hinge part interposed in-between such that the arm is rotatable in a direction intersecting a direction of gravity;
a connection member coupled to the other end of the arm by way of a second hinge part interposed in-between such that the connector member is rotatable in a direction intersecting the direction of gravity; and
a movement member coupled to the connection member by way of a third hinge part interposed in-between such that the movement member is rotatable in the direction of gravity,
wherein a drive part is coupled to each of the first hinge part, the second hinge part, and the third hinge part.

2. The display rotation apparatus of claim 1, wherein an elastic member is coupled between the connection member and the movement member, the elastic member applying an elastic force on the movement member in a direction opposite the direction of gravity.

3. The display rotation apparatus of claim 1, wherein the drive part comprises:
a motor; and
a gear module coupled to the motor and configured to decelerate a rotation speed of the motor.
